(19) United States
(12) Patent Application Publication
(10) Pub. No.: US 2012/0231693 A1
(43) Pub. Date: Sep. 13, 2012

(54) Fluorescent strip light style L.E.D. retrofit wiring methods

(76) Inventor: Andrew Russell Mellon, Seattle, WA (US)

(21) Appl. No.: 13/343,003

(22) Filed: Mar. 21, 2012

Related U.S. Application Data
(60) Provisional application No. 61/416,691, filed on Jan. 6, 2011.

(51) Int. Cl. H01J 9/02

(52) U.S. Cl. 445/2

(57) ABSTRACT

The following depictions are of the retrofit wiring of a fluorescent “strip-light” style fixture for conversion to an LED light. Some of the drawings depict a fixture for use of a single lamp while others depict accommodating multiple lamps. The pattern is essentially the same. The perspective is from inside the fixture looking at the bottoms of the “tombstones” or lamp holders. Notice that there is no ballast included in the depictions. The ballast does not necessarily have to be removed entirely from the fixture, but it may need to be bypassed. There are two basic options of wiring methods used to make the conversion, one for increased safety, the other for economy. The multiple depictions represent the numerous variations of the conversion. FIGS. 1-26 represent wiring for improved safety. FIGS. 27-38 represent wiring for improved economy.

### DESCRIPTION OF THE DRAWINGS

Methods for retrofitting or converting a fluorescent fixture for use of LED lamp(s) [Ref app. #13/343,003 Jan. 4, 2012, provisional patent #61/416,691 Nov. 23, 2010]

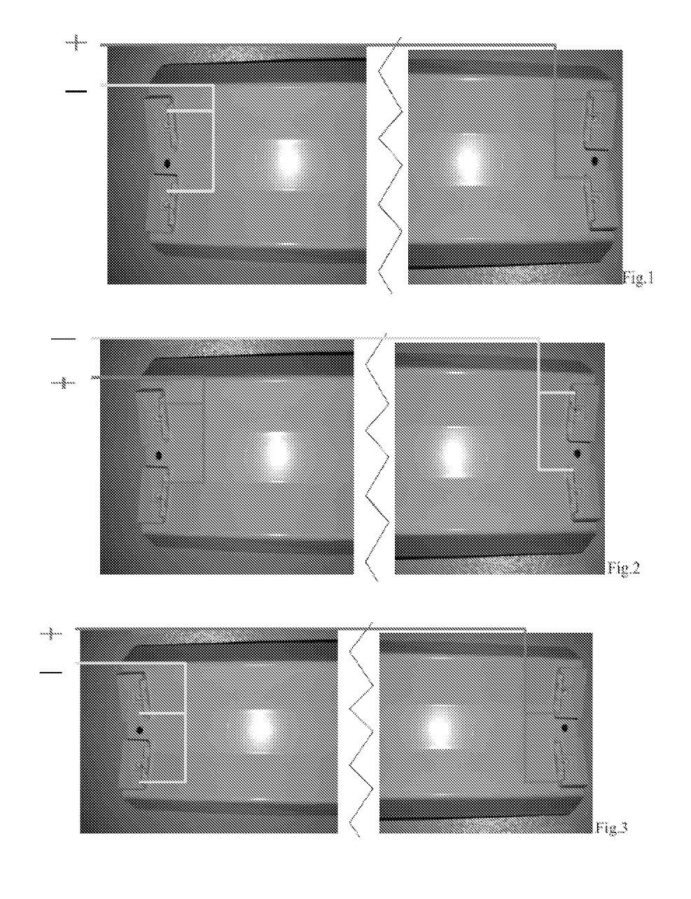

### Option 1: Method of Wiring for Increased Safety. (FIG. 1-26)

Disconnect fixture from any source of power. Gain access to the wiring of the fixture by removing any backing or ballast cover. Once the wiring is exposed, note the termination of each wire into the “tombstones” (or lamp holders). The lamp holders may be located on opposing sides of the fixture. We shall call these sides left (L) and right (R) as the orientation would appear from retrofitter if they were positioned at the middle of the fixture. The ballast may need to be removed or bypassed. Do so by physically cutting the wires and removing the ballast or bypassing the ballast, properly terminating the wires as necessary. Next, take the wires terminating at the lamp holders on the (L) side and connect them to one of the “poles” either Positive or Neutral. Then, take the wires terminating at the lamp holders from the (R) side and connect them to the remaining “pole”. Check all wires for proper termination and the ground wire (if available) for proper grounding. Replace the backing or ballast cover. Indicate that the fixture has been modified for LED usage on the exterior of the fixture.

Advantage: By keeping the terminating poles on opposing sides of the fixture, there are less chances of incident (such as arching, shorting). Disadvantage: Extra materials may be needed to make the connection from the side opposite the “Input” side.

FIG. 1 shows wiring using method for improved safety. Color red=positive and yellow=neutral

FIG. 2 shows wiring using method for improved safety. Color red=positive and yellow=neutral

FIG. 3 shows wiring using method for improved safety. Color red=positive and yellow=neutral

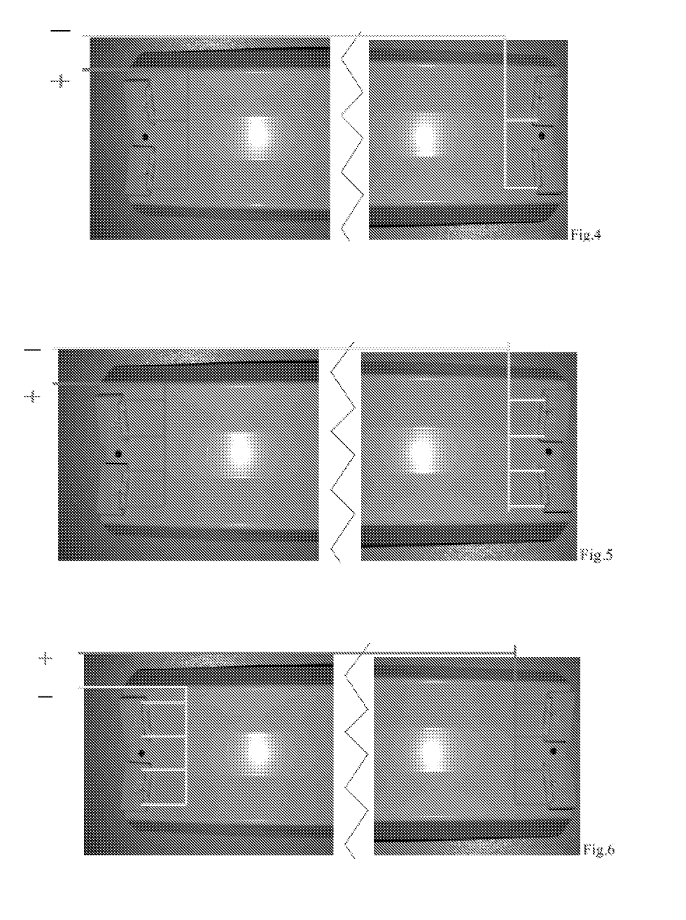

FIG. 4 shows wiring using method for improved safety. Color red=positive and yellow=neutral

FIG. 5 shows wiring using method for improved safety. Color red=positive and yellow=neutral

FIG. 6 shows wiring using method for improved safety. Color red=positive and yellow=neutral

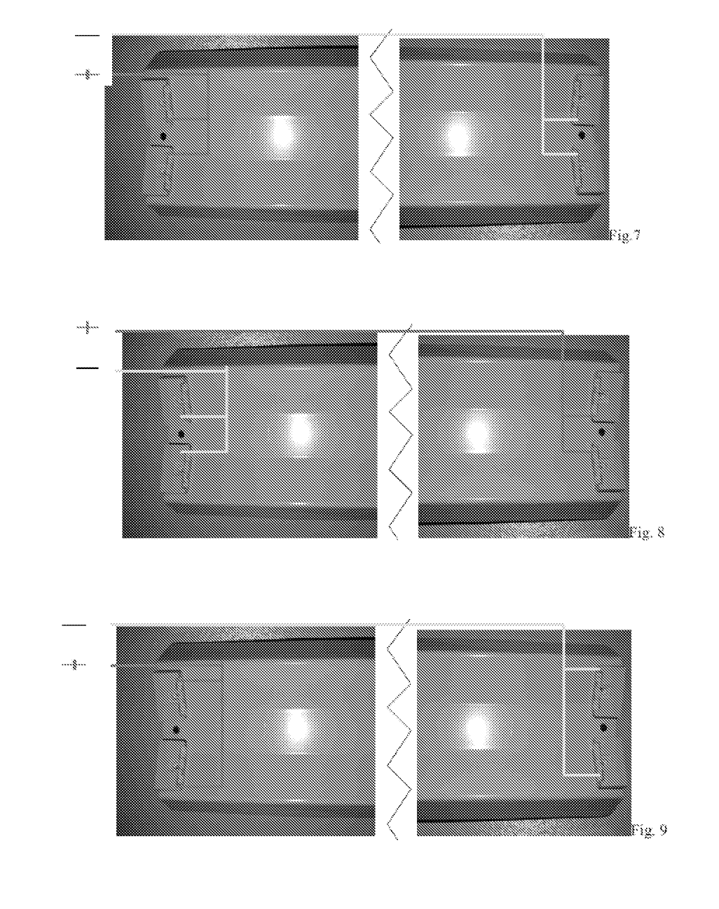

FIG. 7 shows wiring using method for improved safety. Color red=positive and yellow=neutral

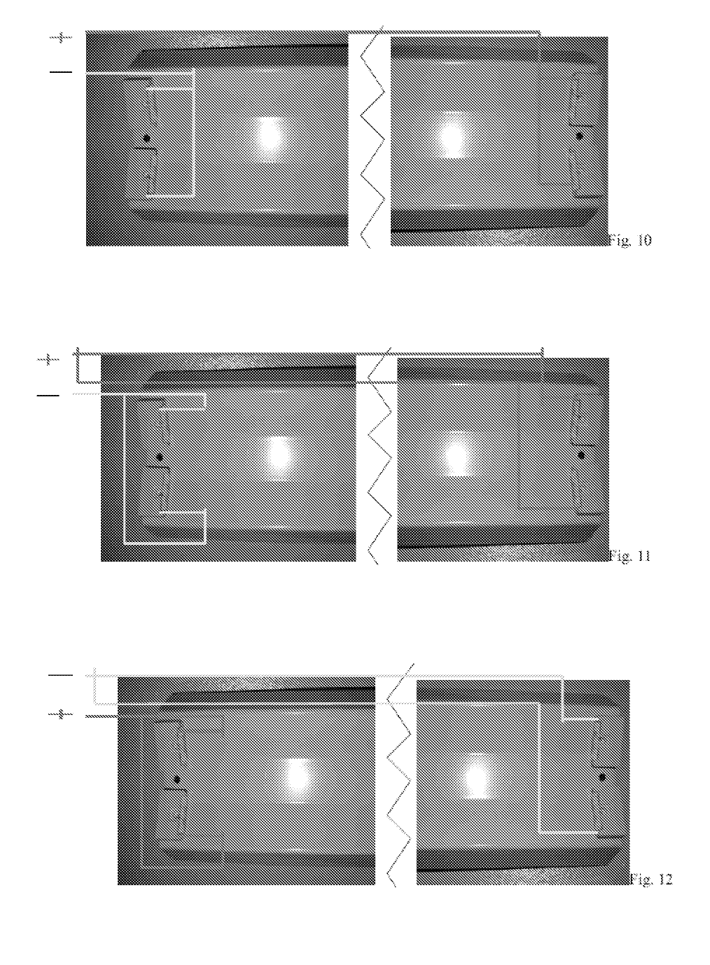

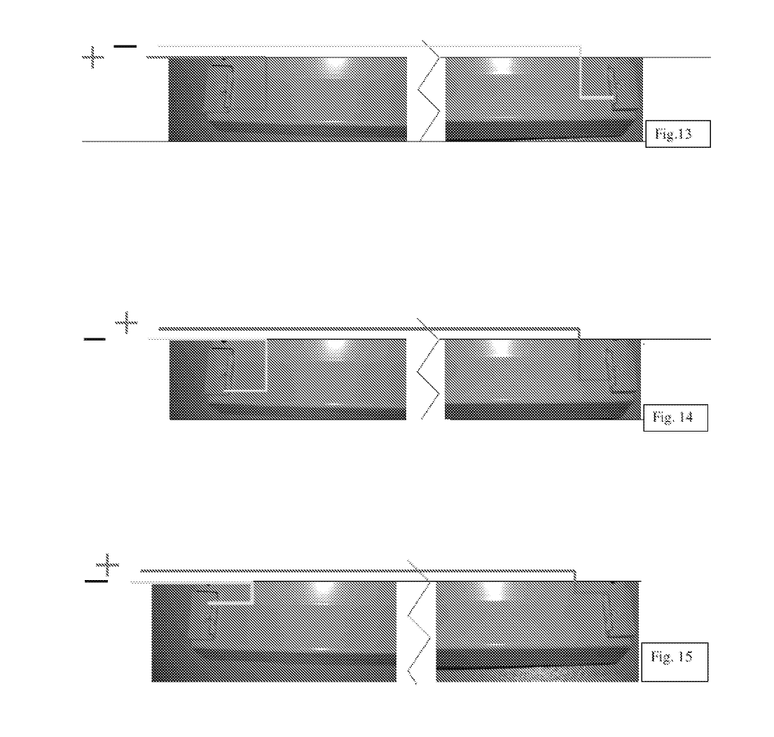

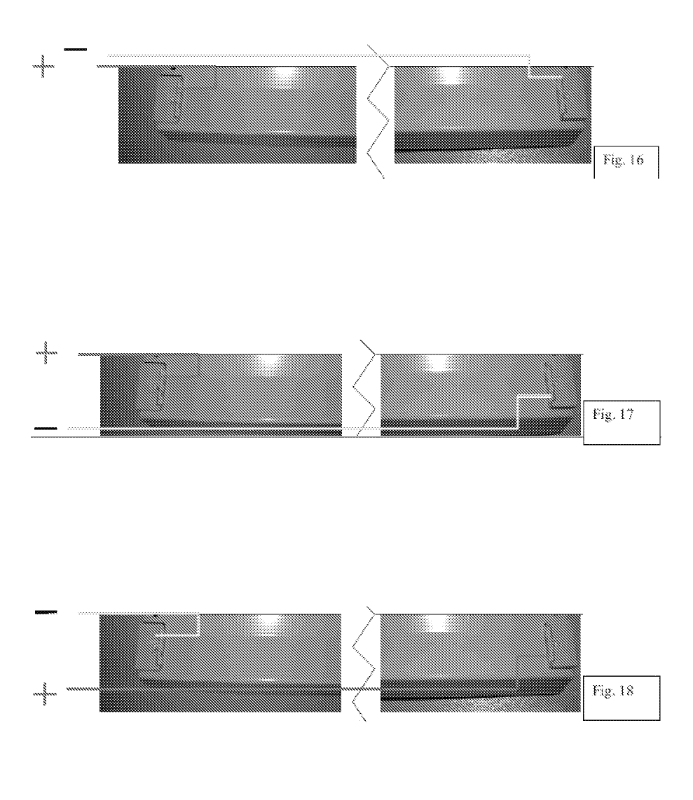

FIG. 8 shows wiring using method for improved safety. Color red=positive and yellow=neutral

FIG. 9 shows wiring using method for improved safety. Color red=positive and yellow=neutral

FIG. 10 shows wiring using method for improved safety. Color red=positive and yellow=neutral

FIG. 11 shows wiring using method for improved safety. Color red=positive and yellow=neutral

FIG. 12 shows wiring using method for improved safety. Color red=positive and yellow=neutral

FIG. 13 shows wiring using method for improved safety. Color red=positive and yellow=neutral

FIG. 14 shows wiring using method for improved safety. Color red=positive and yellow=neutral

FIG. 15 shows wiring using method for improved safety. Color red=positive and yellow=neutral

FIG. 16 shows wiring using method for improved safety. Color red=positive and yellow=neutral

FIG. 17 shows wiring using method for improved safety. Color red=positive and yellow=neutral

FIG. 18 shows wiring using method for improved safety. Color red=positive and yellow=neutral

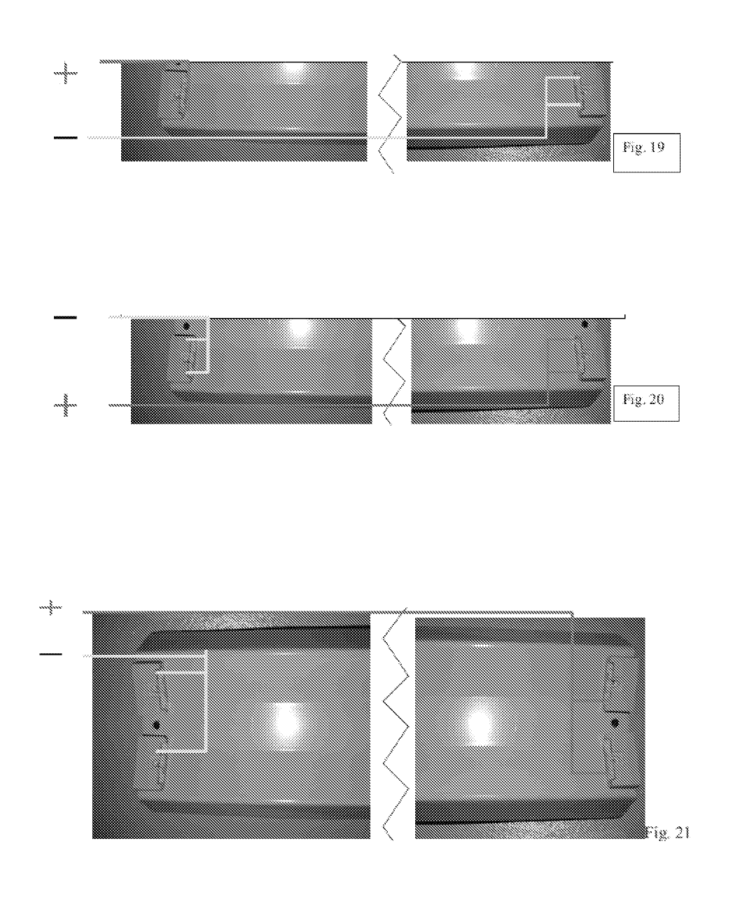

FIG. 19 shows wiring using method for improved safety. Color red=positive and yellow=neutral

FIG. 20 shows wiring using method for improved safety. Color red=positive and yellow=neutral

FIG. 21 shows wiring using method for improved safety. Color red=positive and yellow=neutral

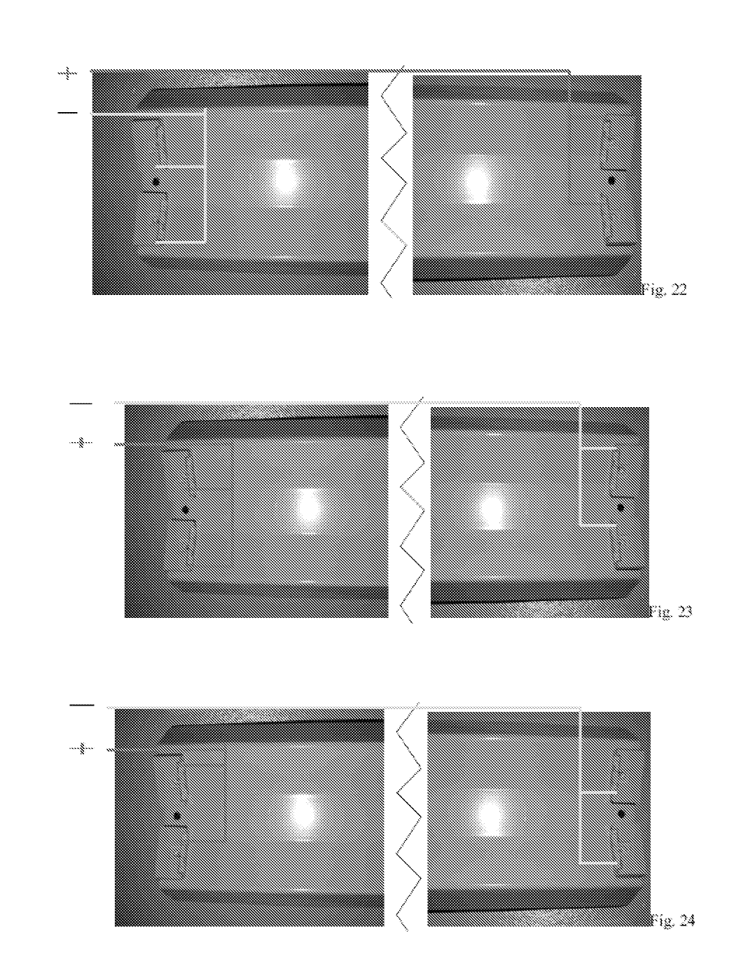

FIG. 22 shows wiring using method for improved safety. Color red=positive and yellow=neutral

FIG. 23 shows wiring using method for improved safety. Color red=positive and yellow=neutral

FIG. 24 shows wiring using method for improved safety. Color red=positive and yellow=neutral

FIG. 25 shows wiring using method for improved safety. Color red=positive and yellow=neutral

FIG. 26 shows wiring using method for improved safety. Color red=positive and yellow=neutral

### DESCRIPTION OF THE DRAWINGS

Methods for retrofitting or converting a fluorescent fixture for use of LED lamp(s) [Ref app. #13/343,003 Jan. 4, 2012, provisional patent #61/416,691 Nov. 23, 2010]

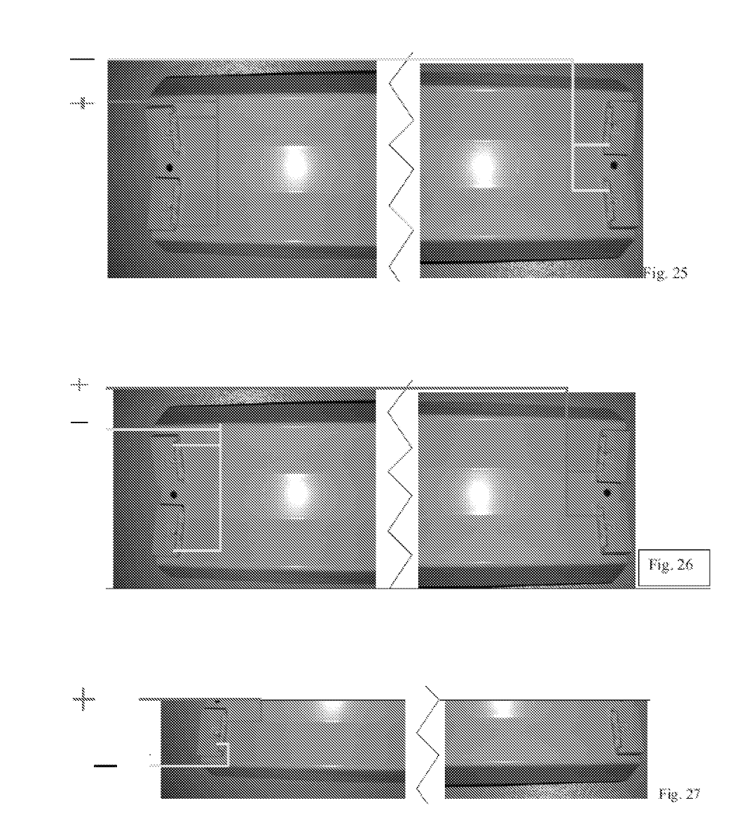

### Option 2: Method of Wiring for Best Economy. (FIG. 27-33)

Disconnect fixture from any source of power. Gain access to the wiring of the fixture by removing any backing or ballast cover. Once the wiring is exposed, note the termination of each wire into the “tombstones” (or lamp holders). The lamp holders may be located on opposing sides of the fixture. Find the “Input” side of the fixture (or the side where the positive and neutral input wires exist). Remove all wiring and ballast(s) except for the wiring that terminates at the “tombstones” (lamp holders) at the “Input” side of the fixture. Now, there is only wiring at the “Input” side of the fixture, terminating at the lamp holders. Of these wires, there must be at least 1 wire per each side of 1 lamp holder. We shall call these sides (of each lamp holder) left (L) and right (R). Symmetry is recommended, so take the (L) side wires of each lamp holder and terminate at the “Input” pole (choose one, either positive or neutral). Then, connect the wires on the (R) side of each lamp holder and connect to the remaining pole. Only the “Input” side of the fixture should have wires terminating at the lamp holders of the “Input” side. The opposing end lamp holders should be “dead” and terminated properly. Check all wires for proper termination and the ground wire (if available) for proper grounding. Replace the backing or ballast cover. Indicate that the fixture has been modified for LED usage on the exterior of the fixture.

Advantages: This method uses less time and materials as the wiring in the “tombstones” (lamp holders) of the “Input” side should already be in place. They simply need to correspond with the correct pole. It is possible that no additional wire will be necessary. Disadvantage: By having the positive and neutral poles terminate at the same “tombstone” (lamp holder), there exists greater chance of incident (i.e. arcing, shorting).

FIG. 27 shows wiring using method for improved economy. Color red=positive and yellow=neutral

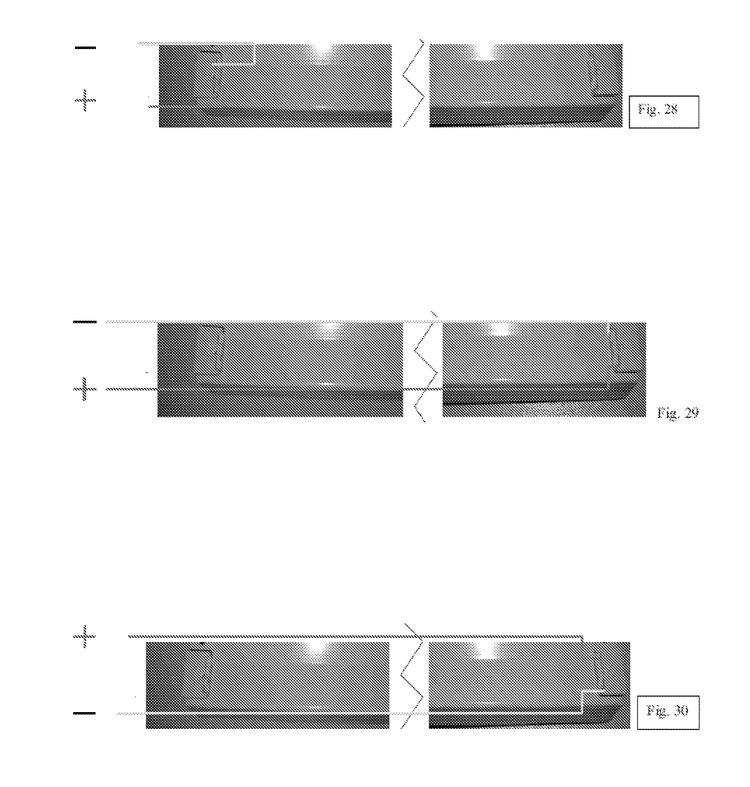

FIG. 28 shows wiring using method for improved economy. Color red=positive and yellow=neutral

FIG. 29 shows wiring using method for improved economy. Color red=positive and yellow=neutral

FIG. 30 shows wiring using method for improved economy. Color red=positive and yellow=neutral

FIG. 31 shows wiring using method for improved economy. Color red=positive and yellow=neutral

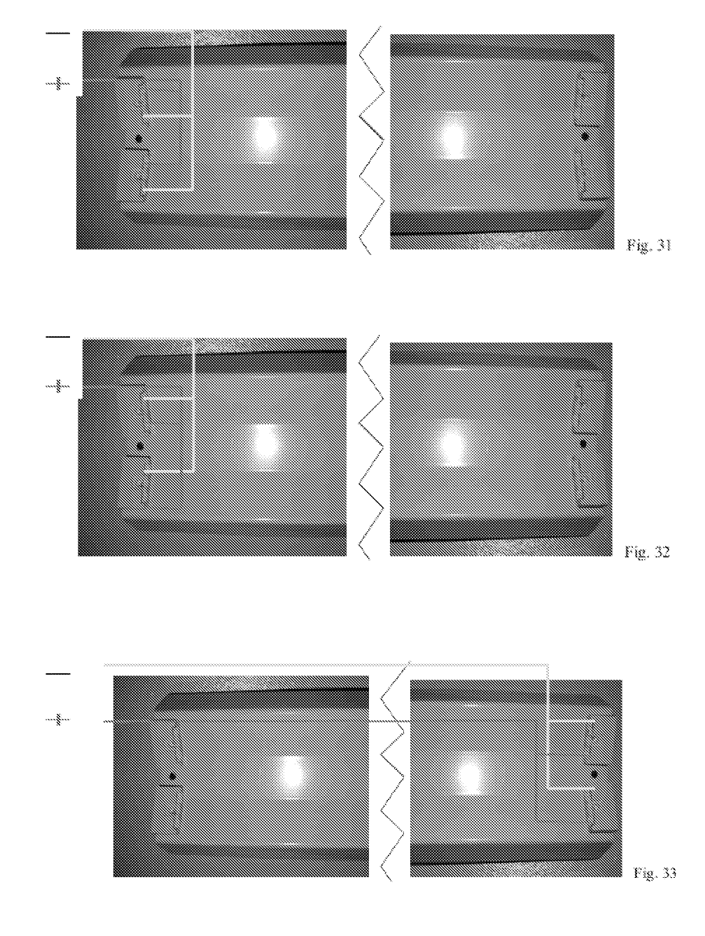

FIG. 32 shows wiring using method for improved economy. Color red=positive and yellow=neutral

FIG. 33 shows wiring using method for improved economy. Color red=positive and yellow=neutral

1. A method for utilizing fluorescent strip-light style fixtures for use with LED lamps.

2. Improving the safety of retrofitting a fluorescent strip-light fixture for use of LED lamps, whereby keeping the positive and neutral terminals at opposing ends.

3. Improving the economy of retrofitting a fluorescent strip-light fixture for use of LED lamps, whereby keeping the positive and neutral terminals on the same end of the fixture.
